(19) United States
(12) Patent Application Publication
(10) Pub. No.: US 2019/0241121 A1
(43) Pub. Date: Aug. 8, 2019

(54) VEHICLE LAMP ASSEMBLY

(71) Applicant: Ford Global Technologies, LLC, Dearborn, MI (US)

(72) Inventors: Hamid M. Golgiri, Dearborn, MI (US); Anthony Melatti, Dearborn, MI (US); Patrick Lawrence Jackson Van Hoecke, Dearborn, MI (US); Danielle Rosenblatt, Dearborn, MI (US)

(73) Assignee: Ford Global Technologies, LLC

(21) Appl. No.: 15/889,746

(22) Filed: Feb. 6, 2018

(51) Int. Cl. B60Q 3/76; B60Q 3/242; B60Q 3/85; B60Q 3/54; F21V 23/04

(52) U.S. Cl. CPC B60Q 3/76; B60Q 3/242; B60Q 3/85; F21Y 2107/30; F21V 23/0471; B60Q 2500/10; B60Q 2900/30; B60Q 3/54

(57) ABSTRACT

A vehicle lamp assembly is provided herein. The vehicle lamp assembly includes a lighting device configured to couple to a headliner. One or more light sources are disposed within the lighting device. A controller is configured to selectively activate the one or more light sources. The illuminated one or more light sources direct light at a feature within a vehicle.

### FIELD OF THE INVENTION

The present disclosure generally relates to vehicle lamp assemblies, and more particularly, to vehicle lamp assemblies within a vehicle cabin.

### BACKGROUND OF THE INVENTION

Vehicle lamp assemblies are employed in vehicles and illuminate for various functions. For some vehicles, it may be desirable to have a vehicle lamp assembly that provides additional illumination within the vehicle.

### SUMMARY OF THE INVENTION

According to one aspect of the present disclosure, a vehicle lamp assembly is provided herein. The vehicle lamp assembly includes a lighting device configured to couple to a headliner. One or more light sources are disposed within the lighting device. A controller is configured to selectively activate the one or more light sources. The illuminated one or more light sources direct light at a feature within a vehicle.

According to another aspect of the present disclosure, a vehicle lamp assembly is provided herein. The vehicle lamp assembly includes a first lighting device having one or more light sources. A second lighting device has one or more light sources. The second lighting device is disposed vehicle rearward of the first lighting device. A controller is configured to selectively activate the first and second lighting devices to direct light at a feature within a vehicle.

According to yet another aspect of the present disclosure, a vehicle lamp assembly is provided herein. The vehicle lamp assembly includes a first lighting device having first and second light sources. A first light-directing element is operably coupled with the first light source and is configured to direct light towards a first vehicle feature. A second light-directing element is operably coupled with the second light source and is configured to direct light towards a second vehicle feature. A controller is configured to selectively activate the first and second light sources.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a front portion of a vehicle having a lamp assembly therein, according to some examples;

FIG. 2 is a top plan view of the vehicle with the lamp assembly having a plurality of lighting devices, according to some examples;

FIG. 3 is a cross-sectional view of one of the lighting devices taken along the line of FIG. 2, according to some examples;

FIG. 4 is a plan view of an array of light sources on a printed circuit board of the lighting device, according to some examples;

FIG. 5 is a plan view of the lighting device including a sensor arrangement, according to some examples;

FIG. 6 is a rear plan view of the cabin of the vehicle and the lamp assembly illuminating in a first illumination pattern, according to some examples;

FIG. 7 is a top plan view of the vehicle with the lamp assembly illuminating in the first illumination pattern, according to some examples;

FIG. 8 is a side plan view of the cabin of the vehicle and the lamp assembly illuminating in a second illumination pattern, according to some examples;

FIG. 9 is a side plan view of the cabin of the vehicle and the lamp assembly illuminating in a third illumination pattern, according to some examples;

FIG. 10 is a side perspective view of the lighting device having a housing movable about a base, according to some examples; and

FIG. 11 is a side perspective view of the lighting device having a stationary base and housing, according to some examples.

### DETAILED DESCRIPTION OF THE PREFERRED EXAMPLES

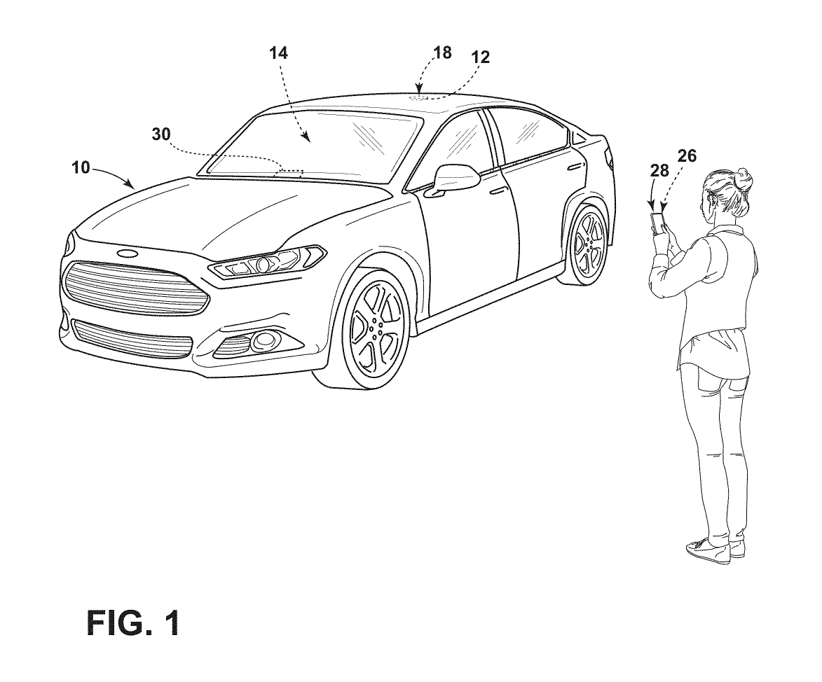

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a lamp assembly that may be disposed within a vehicle cabin. In some examples, the lamp assembly may be configured as an overhead lamp that is disposed above occupants once installed within the vehicle. The lamp assembly may include one or more light sources that are configured to illuminate predefined locations and/or features within the vehicle. The light sources may be selectively activated by a controller 48 based on a plurality of inputs based on detected conditions and/or occupant inputs.

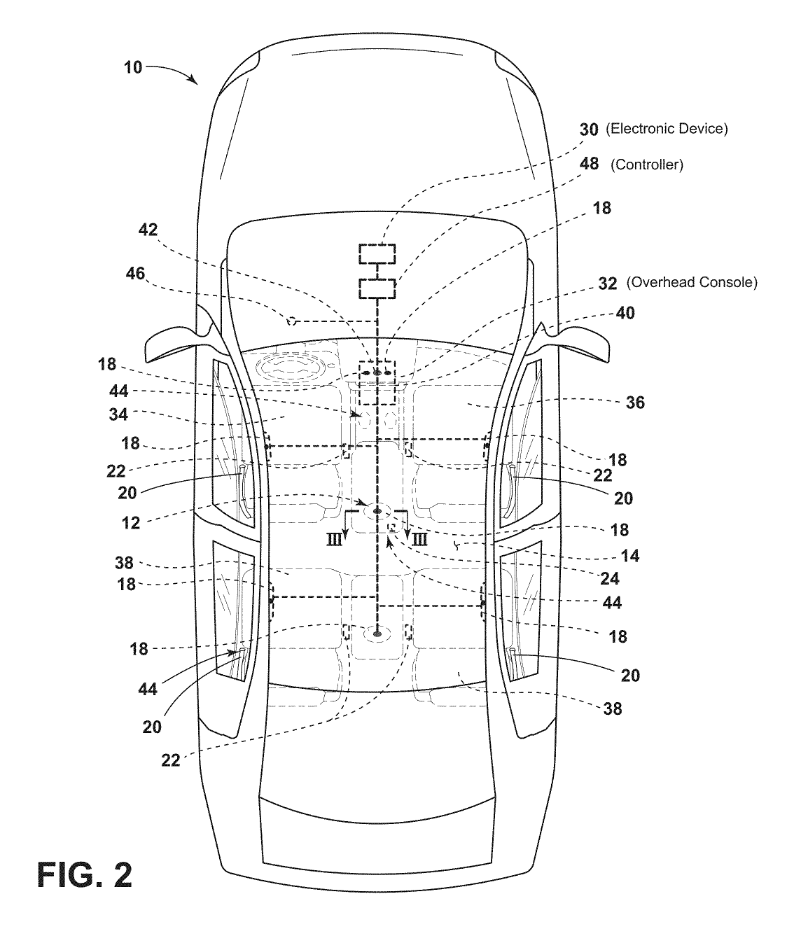

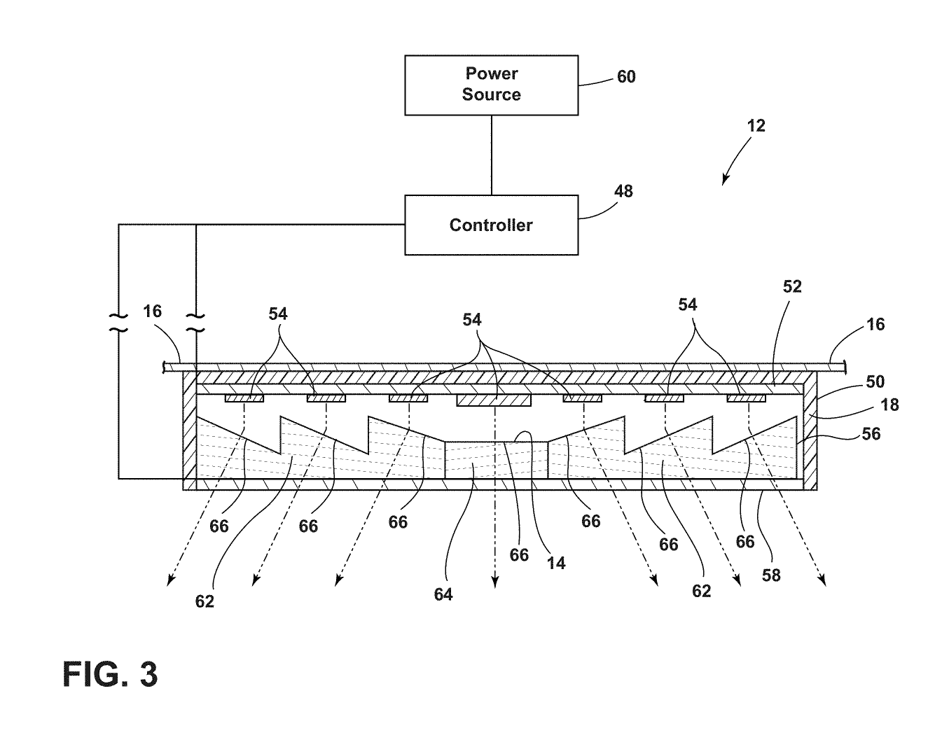

Referring to FIGS. 1 and 2, a vehicle 10 is depicted with a lamp assembly 12 disposed within a cabin 14 of the vehicle 10. In some examples, the lamp assembly 12 may be configured as a dome light and/or any other type of lighting assembly disposed within the cabin 14. In some instances, the lamp assembly 12 may be configured as a single lighting device 18, which may be generally centrally disposed within a headliner 16 (FIG. 3) of the vehicle 10. As used herein, “centrally disposed” will be construed to mean any position between a rear portion of the cabin 14 and a windshield in a vehicle forward/rearward direction and any lateral position within the cabin 14. In alternate instances, the lamp assembly 12 may be configured as a plurality of lighting devices 18 disposed within the cabin 14. When the lamp assembly 12 is activated, a light pattern is transmitted towards a predefined location within the cabin 14. In some examples, the lamp assembly 12 may be configured to illuminate predefined features 44 of the vehicle 10, such as seatbelts 20, seatbelt latch 22, electronic ports 24, and/or any other feature 44 within the vehicle 10 simultaneously or independently. Additionally, in some aspects, the lamp assembly 12 may be utilized for a wide variety of purposes, including but not limited to, task lighting, feature lighting, ambient lighting, and/or notification lighting.

With further reference to FIGS. 1 and 2, the vehicle 10 may be utilized for personal and/or commercial purposes, such as for ride-providing (chauffeuring) services and/or ride-sharing services. An application 26 associated with the commercial purpose of the vehicle 10 may be installed on a user's electronic device 28. The application 26 may be configured to communicate with the vehicle 10 (either directly and/or through a remote station) and/or a vehicle associated electronic device 30 that may be disposed within the vehicle 10 and/or remotely disposed. Through the communication between the user's electronic device 28 and the vehicle associated electronic device 30, a commercial relationship may be established in which the vehicle 10 is used to facilitate a service.

The user's electronic device 28 and the vehicle associated electronic device 30 may be any one of a variety of computing devices and may include a processor and memory. For example, the user's electronic device 28 and the vehicle associated electronic device 30 may be a cell phone, mobile communication device, key fob, wearable device (e.g., fitness band, watch, glasses, jewelry, wallet), apparel (e.g., a tee shirt, gloves, shoes or other accessories), personal digital assistant, headphones and/or other devices that include capabilities for wireless communications using IEEE 2.11, Bluetooth, and/or any other wired or wireless communications protocols. Further, the vehicle associated electronic device 30 may be a computer or any other electronic device that is disposed within the vehicle 10.

In various examples, the vehicle 10 and/or the vehicle associated electronic device 30 may communicate with the user's electronic device 28 through a wireless network. Accordingly, the network may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 2.11, etc.), local area networks (LAN), and/or wide area networks (WAN), including the Internet, providing data communication services.

Moreover, the vehicle 10 and/or the vehicle associated electronic device 30 may include a wireless transceiver (e.g., a BLUETOOTH module, a ZIGBEE transceiver, a Wi-Fi transceiver, an IrDA transceiver, an RFID transceiver, etc.) configured to communicate with a compatible wireless transceiver of the user's electronic device 28. Additionally or alternatively, the vehicle 10 and/or the vehicle associated electronic device 30 may communicate with the user's electronic device 28 over a wired connection, such as via a USB connection.

The application 26 may be configured to utilize a device link interface to interact with the vehicle 10 and/or the vehicle associated electronic device 30. When connected to the vehicle 10, the application 26 may be configured to utilize information from vehicle sensors, actuators, and electronic control units. The application 26 may also be configured to operate when untethered from the vehicle 10, such as when the user is riding public transportation or walking. The application 26 may be further configured to communicate with servers via a communications network. The user may interact with the application 26 through a human-machine interface (HMI) 40 of the vehicle associated electronic device 30, via a web interface, or via the HMI 40 of the vehicle 10.

The vehicle 10 may be a manually operated vehicle (i.e. using a human driver) or may be autonomously driven by an onboard computer. Additionally, or alternatively, the vehicle 10 may be remotely controlled (e.g., via an operator located in a different location). In autonomous examples, the computer may be configured for communicating with one or more remote sites such as a server via a network. The one or more remote sites may include a data store. The vehicle 10, including the computer, is configured to receive information, e.g., collected data, from the one or more data collectors related to various components of the vehicle 10, e.g., a steering wheel, brake pedal, accelerator pedal, gearshift lever, etc. The computer generally includes an autonomous driving module that includes instructions for autonomously, i.e., without some, or any, operator input, operating the vehicle 10, including possibly in response to instructions received from the server. Further, the computer, e.g., in the module, generally includes instructions for receiving data, e.g., from one or more data collectors and/or an HMI 40, such as an interactive voice response (IVR) system, a graphical user interface (GUI) including a touchscreen or the like, etc.

The application 26 on the user's electronic device 28 and/or vehicle associated electronic device 30 may also be configured to alter lighting characteristics of the lamp assembly 12. For example, a user may alter the color of light emitted from the lamp assembly 12, alter the intensity of light emitted from the lamp assembly 12, and/or set parameters for activation of the lamp assembly 12, as will be described in greater detail below. For example, the lamp assembly 12 may illuminate in a first color (e.g., red) when an occupant enters the vehicle 10 and fails to secure an occupant restraint device (e.g., seatbelt 20) in the occupied seat and/or illuminate in a second color (e.g., green) when the occupant desires to utilize a feature 44 of the vehicle 10, such as the electronic port 24.

Referring further to FIG. 2, the vehicle 10 may include a plurality of lighting devices 18 in conjunction with, or in lieu of, the generally centrally disposed lighting device 18. For example, as illustrated in FIG. 2, the lamp assembly 12 may include an overhead console 32 having lighting devices 18 therein, the generally centrally disposed lighting device 18, and/or a rear lighting device 18. Additionally, and/or alternatively, the vehicle 10 may include outwardly disposed lighting devices 18 positioned over, and/or in close proximity to, one or more front seats 34, 36 and/or rear seats 38 disposed within the vehicle 10.

The vehicle 10 may further include one or more HMIs 40 that may be operably coupled with the lamp assembly 12 and utilized for illuminating the lamp assembly 12 in a variety of illumination patterns. The vehicle 10 may also include a microphone 42 that is also operably coupled to the controller 48. The microphone 42 may be a unidirectional microphone or an array of microphones. If the microphone 42 is a unidirectional microphone, the microphone is disposed, for example, in such a manner that the directivity thereof is directed toward the head of an occupant. An array microphone is a microphone in which multiple microphones are arranged close to each other in an array and whose directivity can be directed in any direction by signal processing. In some examples, an occupant within the cabin 14 may provide one or more commands and/or questions. In response, the lamp assembly 12 may illuminate in a predefined manner. In some instances, an occupant may be able to ask for a location of the electronic port 24, or any other feature 44, within the vehicle 10. In response, the controller 48 may illuminate a portion of the lamp assembly 12 that directs light at the desired feature 44. It will be appreciated that any feature 44 within the cabin 14 of the vehicle 10 may be illuminated in such a manner without departing from the teachings provided herein. Accordingly, the microphone 42 is operably coupled to the controller 48 and the lighting device 18 selectively illuminates one or more light sources 54 based on a user-provided voice command. For example, an occupant may ask for a door handle to be illuminated, for the electronic port 24 to be illuminated, for a cup holder to be illuminated, etc. and in response, the lamp assembly 12 may illuminate the appropriate light sources 54 (FIG. 3) to illuminate the desired feature 44. Further, the commands may also be inputted through one or more HMIs 40 within the vehicle 10 and the lamp assembly 12 may illuminate.

With further reference to FIG. 2, the lamp assembly 12 may activate various light sources 54 based on requests from the user's electronic device 28 and/or vehicle associated electronic device 30. For example, the lamp assembly 12 may direct an incoming occupant to a front seat position within the cabin 14 by illuminating a front seating position proximate the front door. Additionally, and/or alternatively, the lamp assembly 12 may direct an incoming occupant to a rear seat position within the cabin 14 by illuminating the seating position proximate a rear door of the vehicle 10.

The vehicle 10 may further include a sound system therein that includes one or more speakers. The speakers may be disposed proximate each seating location. Accordingly, in addition to, or in lieu of, the speaker proximate each respective seating area may assist in locating various features 44 of the vehicle 10. For example, in addition to the lamp assembly 12 illuminating the vehicle feature 44, the speaker proximate the seating area may direct the occupant to the location of the specific feature 44.

Additionally, the application 26 on the electronic device 28 may include a plurality of identifiable features 44 of the vehicle 10 that may be illuminated by the lamp assembly 12. Accordingly, when an occupant is unable to identify the location of a desired feature 44, that feature 44 can be selected through the electronic device 28. In response, the lamp assembly 12 may illuminate a portion thereof to direct light towards the desired feature 44. In some examples, the lamp assembly 12 may also illuminate safety features 44 of the vehicle 10 based on an input from the central area network (CAN) bus of the vehicle 10. For example, if the vehicle 10 detects an occupant within a specific location of the vehicle 10 and the seatbelt 20 for that location is disengaged, the lamp assembly 12 may illuminate the respective seatbelt 20, the identified seat, the occupant, and/or the seatbelt latch 22. Any other feature 44 that may be utilized in a similar manner may also be illuminated without departing from the scope of the present disclosure.

In some examples, the lamp assembly 12 includes a controller 48 including control circuitry including LED drive circuitry for controlling activation and deactivation of one or more light sources 54. The controller 48 may be disposed in the vehicle 10, within the vehicle associated electronic device 30, and/or within the lighting device 18. The controller 48 may activate the light sources 54 based on a plurality of inputs from the vehicle associated electronic device 30, the user electronic device 28, the HMI 40, any sensor within the vehicle 10, etc. and may modify the intensity of the light emitted by the light sources 54 by pulse-width modulation, current control, and/or any other method known in the art. In various examples, the controller 48 may be configured to adjust a color and/or intensity of light emitted from the light sources 54 by sending control signals to adjust an intensity or energy output level of the light sources 54.

With further reference to FIG. 2, the vehicle 10 includes a light-detecting device 46 that may be utilized for varying the intensity of light emitted from the lamp 32. The light-detecting device 46 senses the environmental lighting conditions, such as whether the vehicle 10 is in day-like conditions (i.e., higher light level conditions) and/or whether the vehicle 10 is in night-like conditions (i.e., lower light level conditions). The light-detecting device 46 can be of any suitable type and can detect the day-like and night-like conditions in any suitable fashion. For instance, in some examples, the light-detecting device 46 includes a light sensor that detects the amount of light (e.g., solar radiation) affecting the vehicle 10 for determining whether day-like or night-like conditions exist. According to some examples, the colors of light and/or intensities of light emitted from the lamp assembly 12 may be varied based on the sensed conditions. For example, the lamp assembly 12 may emit light of high intensity in any color during day-like conditions. Additionally, and/or alternatively, the lamp assembly 12 may be configured to emit light of the first color and low intensity in the second color in night-like conditions while the vehicle 10 is in motion. Once the vehicle 10 is in a parked state, the lamp assembly 12 may emit light in a high intensity in the second color.

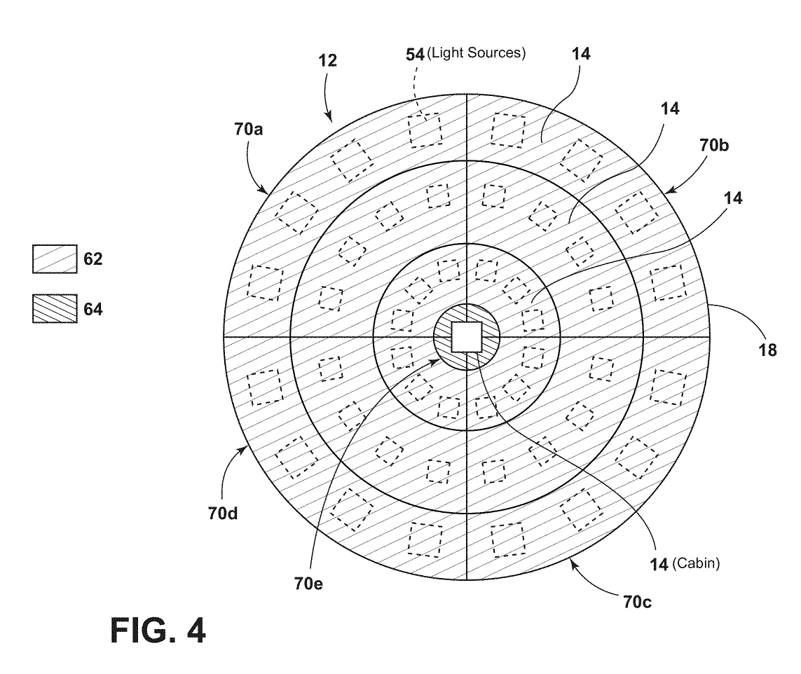

Referring to FIGS. 3 and 4, the lighting device 18, according to some examples, is defined by a housing 50. The housing 50 may at least partially encompass a circuit board 52, one or more light sources 54, optics 56, and/or a sensor assembly 58.

The circuit board 52 may be configured as a printed circuit board (PCB) that is operably coupled to the controller 48. The circuit board 52 may be configured in any fashion known in the art including, but not limited to, any flexible PCB and/or rigid PCB. The light sources 54 may be disposed on the circuit board 52 with constant or variable spacing. The light sources 54 may include any form of light sources. For example, fluorescent lighting, light-emitting diodes (LEDs), organic LEDs (OLEDs), polymer LEDs (PLEDs), laser diodes, quantum dot LEDs (QD-LEDs), solid-state lighting, a hybrid of these or any other similar device, and/or any other form of lighting may be utilized within the lighting device 18. Further, various types of LEDs are suitable for use as the light sources 54 including, but not limited to, top-emitting LEDs, side-emitting LEDs, and others. Moreover, according to various examples, multicolored light sources 54, such as Red, Green, and Blue (RGB) LEDs that employ red, green, and blue LED packaging may be used to generate various desired colors of light outputs from a single light source 30, according to known light color mixing techniques.

Referring to FIGS. 3 and 4, one of the light sources 54 may be arranged in the center of the circuit board 52 and the remaining light sources 54 are arranged in several rings thereabout. As is exemplarily shown in FIG. 4, the circuit board 52 may have a circular configuration and the spacing between light sources 54 in the same ring may increase the closer they are to the edge of the circuit board 52. The light sources 54 may be configured to emit any colored light and are electrically coupled to the controller 48. In operation, the controller 48 may selectively control the light sources 54 such that one, all, or a portion of the light sources 54 can be activated at any given time. The controller 48 may be located on the circuit board 52 or elsewhere in the vehicle 10 and is electrically coupled to a power source 60, which includes a conventional vehicle power source or an independent power source.

The optics 56 includes one or more light-directing elements 66. The light-directing elements 66 are arranged such that a first portion 62 of the light-directing elements 66 is configured to output incident light at an angle and another portion 64 of the light-directing elements 66 is configured to output incident light at a zero angle as demonstrated by the light rays in FIG. 3. In the illustrated example, a second portion 64 may include a single light-directing element 66 having a planar shape whereas the first portion 62 includes a plurality of light-directing elements 66 in a sawtooth arrangement for directing incident light away from the center of the optics 56. As shown in FIG. 4, the light-directing element 66 of the second portion 64 may have a circular shape and is located at the center of the optics 56 whereas the light-directing elements 66 of the first portion 62 are each arranged as rings that are concentric with the second portion 64. In assembly, the optics 56 is positioned relative the circuit board 52 such that the light-directing element 66 of portion 64 is in optical communication with the light sources 54 located at the center of the circuit board 52 and the light-directing elements 66 of portion 62 are in optical communication with a corresponding ring of light sources 54. In various examples, the light-directing elements 66 may be configured as a Fresnel lens, a pillow optic, and/or any other type of lens or optic that is configured to disperse, concentrate, and/or otherwise, direct light emitted from the one or more light sources 54 therethrough in any desired manner.

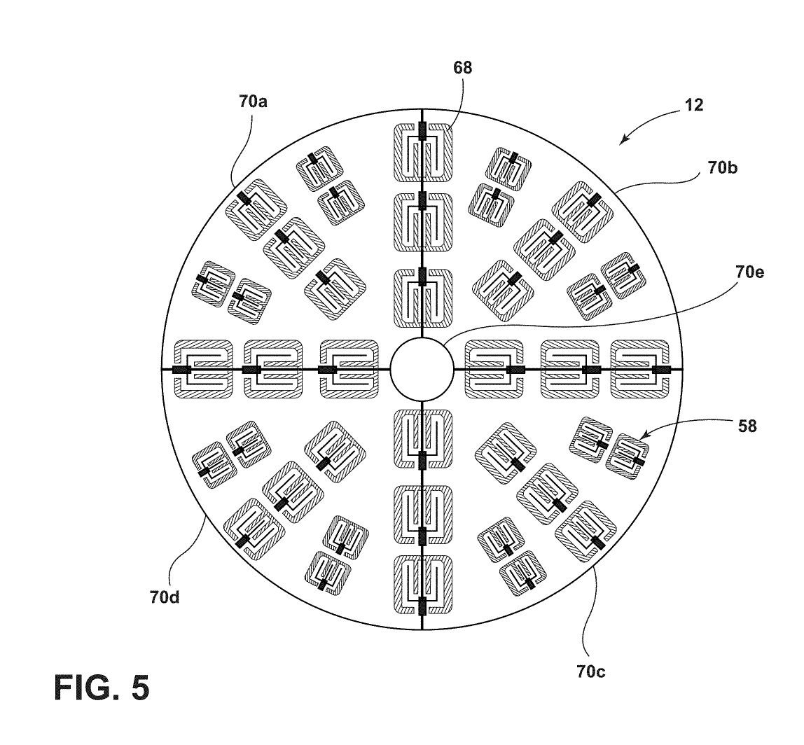

Referring to FIGS. 4 and 5, the sensor assembly 58 may also be electrically coupled to the controller 48 and may include an array of proximity sensors 68 as exemplarily shown in FIG. 5. The proximity sensors 68 may include capacitive sensors or other sensors configured to sense a user-supplied action such as a touch event and/or a gesture. Capacitive sensors generally detect changes in capacitance due to the placement or movement of an object such as a finger proximate to or in contact with the sensor, thereby allowing a variety of user-supplied actions to be effectuated on the sensor assembly 58 to control the light output of the lamp assembly 12. Examples of user-supplied action include using one or more hand digits to tap or swipe the sensor assembly 58 as well as using hand gestures proximate the sensor assembly 58. In alternative examples, the sensor assembly 58 may include other types of proximity sensors such as, but not limited to, magnetic sensors, inductive sensors, optical sensors, resistive sensors, temperature sensors, the like, or any combination thereof.

According to some examples, the lighting device 18 may be divided into a plurality of light-emitting regions, exemplarily shown in FIGS. 4 and 5 as a first region 70a, a second region 70b, a third region 70c, a fourth region 70d and a fifth region 70e, respectively. The regions 70a-70e may be visually identified to the user or otherwise left unidentified. Each region 70a-70e includes a corresponding portion of the sensor assembly 58, as well as the portions of the optics 56 and the light sources 54 located thereunder. In this way, the lamp assembly 12 can be positioned within the vehicle 10 such that each region 70a-70e illuminates a distinct area by virtue of the light-directing elements 66 of optics 56. In operation, each region 70a-70e may be selectively activated in response to a touch event on the sensor assembly 58, an activation request based on an electronic device 28, 30 input, an activation request based on an HMI 40 input, an activation request based on a voice command, an activation request based on a sensed vehicle condition, etc.

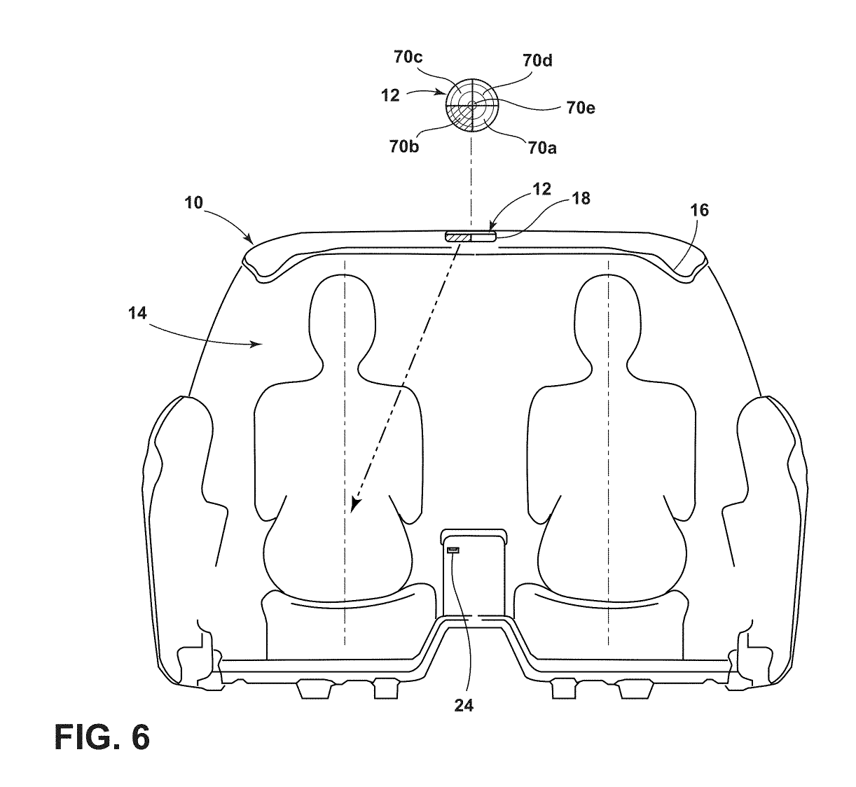

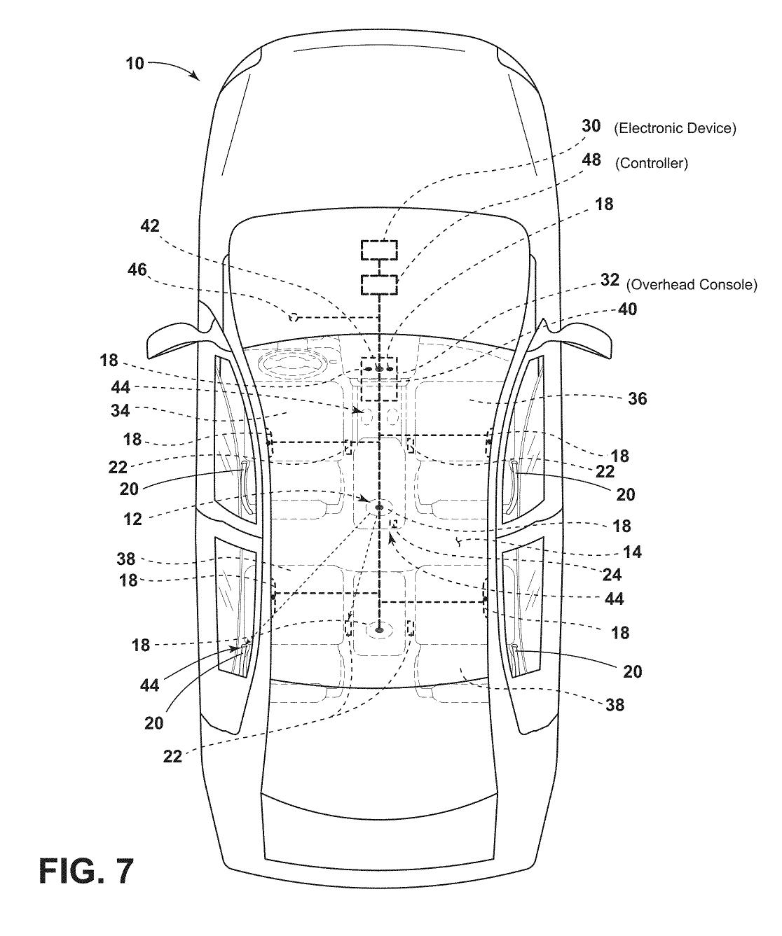

Referring to FIGS. 6 and 7, in some instances, an occupant may be disposed within a rear driver-side seating position within the vehicle 10. To illuminate the seating position and/or a feature 44 proximate the seating position, the controller 48 may activate the light sources 54 associated with region 70b. The illumination may be used as task lighting, functional light, ambient lighting, and/or for any other reason. As provided herein, the illumination may be activated in response to an activation request by the occupant. Alternatively, the activation may occur to notify the occupant of a feature location, such as a seatbelt 20, when the vehicle 10 detects an unlatched condition.

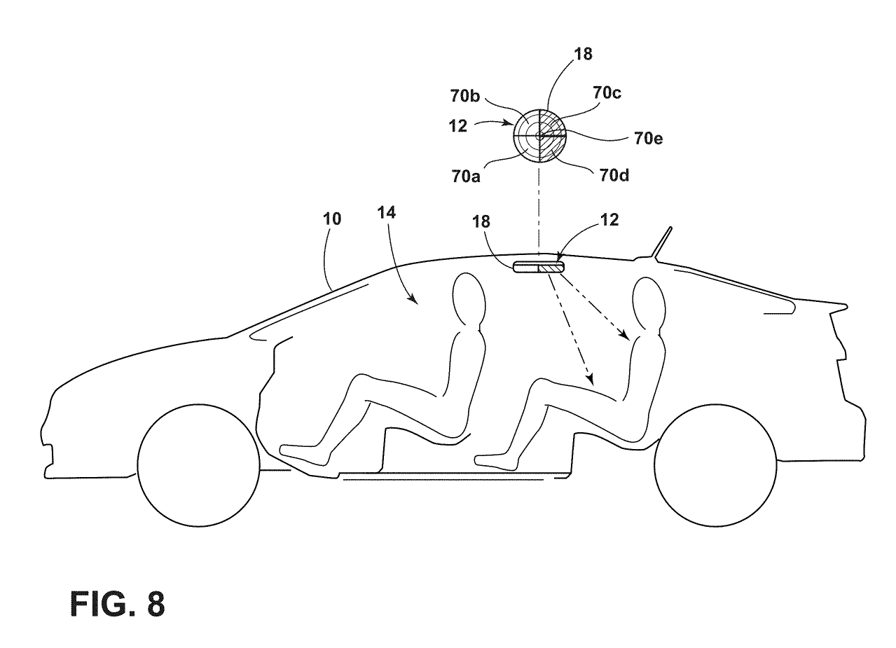

Referring to FIG. 8, the lamp assembly 12 may illuminate various portions simultaneously to illuminate various locations and features 44 within the vehicle 10. For example, in examples in which the occupant is to be seated in a specific seating location of the vehicle 10, the lamp assembly 12 may direct the incoming occupant to that location. The lamp assembly 12 and/or portions thereof may sequentially illuminate and/or deactivate based on a wide array of conditions. For example, the lamp assembly 12 may have a timeout period wherein the light sources 54 deactivate after a set amount of time. Additionally, and/or alternatively, the lamp assembly 12 may be deactivated for any other reason, including, but not limited to, arriving at an occupant's destination, the feature 44 desired is detected to have been found, and/or the vehicle feature 44 is disposed in a desired state. For example, if the occupant desired to locate the electronic port 24 within the cabin 14 and locates the electronic port 24, the connection of an electronic device 28 to the port may deactivate the light sources 54. Furthermore, the latching of an unbuckled seatbelt 20 may also deactivate light sources 54 that illuminate the seatbelt 20. It will be appreciated that the illumination sequence provided herein may be utilized to illuminate any feature 44 or features 44 within the vehicle 10 independently or simultaneously without departing from the scope of the disclosure.

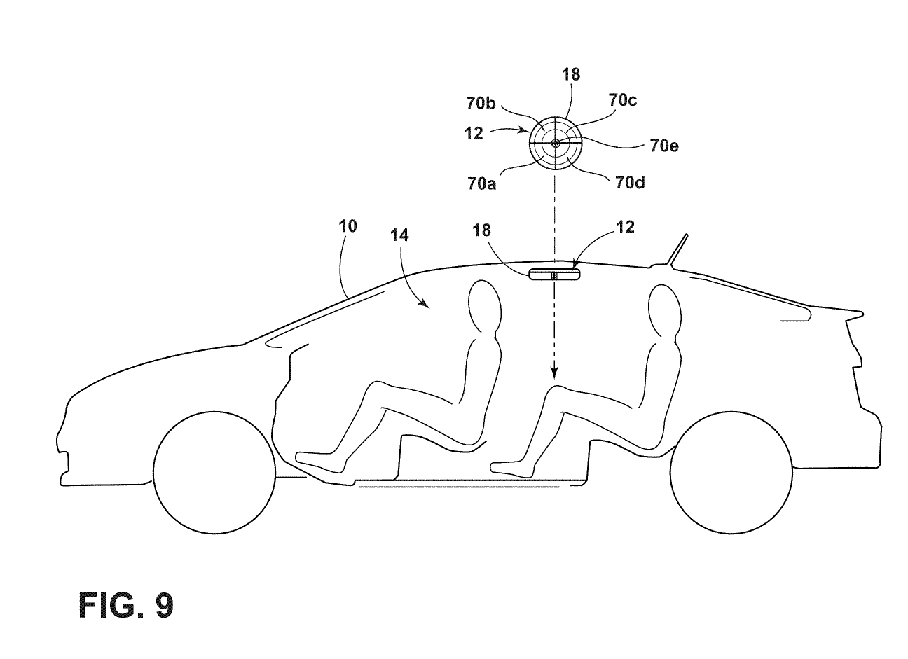

Referring to FIG. 9, in some examples, region 70e, like all other regions, may be activated independently of the remaining regions 70a-70d. As a result, the controller 48 activates the light sources 54 located at the center of the lighting device 18 is activated, which results in region 70e illuminating an area thereunder. Region 70e may be directed towards any desired feature 44 without departing from the scope of the present disclosure. Moreover, the lighting device 18 may be in any location within the cabin 14 and the pin spot may illuminate any location within and/or proximate to the cabin 14.

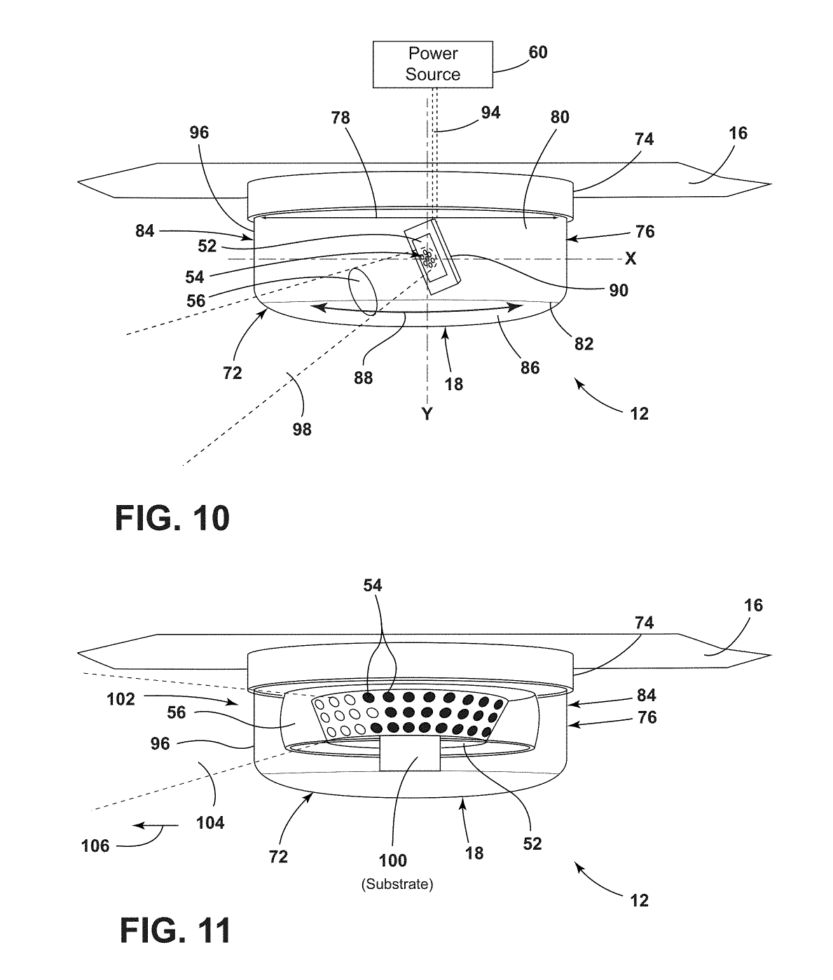

Referring to FIGS. 10 and 11, the lighting device 18 is configured to project one or more light beams in various directions and/or towards various locations within the vehicle 10, as provided herein. In some examples, the directionality of the light beam 22 may be controlled using the electronic device 28, 30, an HMI 40, and/or through any other assemblies described herein. In some examples, the lighting device 18 is operable such that the directionality of the light beam 22 is configured to illuminate a desired feature 44 within the cabin 14.

Referring to FIG. 10, the lighting device 18 includes a housing assembly 72 pivotally coupled to the headliner 16. The housing assembly 72 includes a base 74 affixed to the headliner 16 using mechanical fasteners or other known means. The base 74 may be constructed from a rigid material. The housing assembly 72 also includes a body 76 aligned with the base 74 and coupled thereto to pivot about a vertical axis Y extending through the body 76 and the base 74 such that the body 76 is rotatable in either a leftward direction or a rightward direction as generally represented by dual directional arrow 88. It is contemplated that the body 76 may be fully rotatable (e.g., 360 degrees) or otherwise limited to a degree of rotation in one or both the leftward and rightward directions. The body 76 may be constructed from a rigid material and is defined by a closed bottom end portion 80 proximate to the base 74, an open top end portion 82, and a light-transmissive peripheral wall 84 extending vertically between the bottom and top ends 80, 82. A cover 86 is affixed to the top end portion 82 of the body 76 and generally functions to seal the contents thereof. The cover 86 may be rounded and constructed from a rigid or elastic material. Additionally, the cover 86 may be light-transmissive or light-blocking.

With continued reference to FIG. 10, the circuit board 52 having the light sources 54 thereon may be pivotably disposed within the body. The optics 56 is optically coupled to the light sources 54. The circuit board 52 and light sources 54 may be pivotable about a horizontal axis X extending laterally across the lighting device 18 such that any of the light device components supported thereby can be rotated in either an upward direction or a downward direction as generally represented by dual directional arrow 88. In some examples, the horizontal axis X may intersect with the vertical axis Y such that the lamp assembly 12 is rotatable in a leftward/rightward direction and an upward/downward direction about a point of intersection 90 between the horizontal axis X and the vertical axis Y. The degree of rotation in both the upward and downward directions may be unrestricted or otherwise limited.

The light sources 54 may be configured to emit light towards a lens assembly 92. The light sources 54 may emit light of the same color or be apportioned to selectively emit different colored light. Electrical power is supplied to the light sources 54 via wiring 94 that is electrically coupled to the vehicle power source 60. The lens assembly includes optics 56 that are positioned between the light sources 54 and a peripheral wall 84 of the body 76 and are configured to focus, collimate, or spread light emitted by the light sources 54 to project a light beam 98 of variable light density outwardly from the body 76 through the peripheral wall 84. In examples where the optics 56 collimate light emitted by light sources 54, the optics 56 may be fluted, the flutes having varying width, height, and depth. Furthermore, the beam pattern of the projected light beam 98 may be defined based on an optical interaction between the optics 56 and the peripheral wall 84. Accordingly, it is to be appreciated that the peripheral wall 84 may be configured to exhibit various optical characteristics.

Referring to FIG. 11, the lighting device 18 is shown according to an alternative example. However, as provided herein, the lamp assembly 12 may include any number of lighting devices 18 within the cabin 14 that are formed in any manner provided herein without departing from the scope of the present disclosure. In some examples of the lighting assembly, the base 74 may be omitted in favor of coupling the body 76 to the roof structure 16. Alternatively, the body 76 and the base 74 may be unitary in construction. A multi-directional light array is defined by the circuit board 52 having a circular arrangement and a plurality of light sources 54 disposed thereon within the housing assembly. The circuit board 52 may be a flex circuit and is supported by a substrate 100 fixedly secured within the housing assembly 72. As shown, the plurality of light sources 54 is exemplarily arranged in three rows of equal number and span a substantial entirety of the circuit board 52. In alternative examples, the number of rows may be different along with the pattern in which the light sources 54 are distributed. For purposes of illustration, an arbitrary number of light sources 54 are undarkened to represent a light source cluster that is selectively activated to emit light outwardly from the body 76 through the peripheral wall 84. Thus, the one or more light sources 54 may be disposed in a circular arrangement and emit circumferentially about the housing towards a desired illumination location within the vehicle 10. It should be appreciated that other light source clusters may be activated to emit light having a different directionality by virtue of the location of the light source clusters on the circuit board 52. Furthermore, by modifying the number of light sources 54 in a given cluster, the intensity and/or spread of the associated light emission may be adjusted. The circuit board 52 may be a vertical orientation and/or be angled to direct the light sources 54 in a downward orientation.

With respect to the presently depicted example, a lens assembly 102 may be optionally provided to focus, collimate, or spread light emitted by the light source cluster to project a light beam 104 of variable light density outwardly from the body 76 through the peripheral wall 84 in the direction generally specified by arrow 106. The lens assembly 102 includes optics 56 in optical communication with the light sources 54 and is fixedly supported within the housing assembly 72 by any suitable means. The optics 56 are generally positioned inside the housing assembly 72 to intercept light emitted from the light sources 54 and project the corresponding light beam through the peripheral wall 84 of the body 76. In some examples, the optics 56 may be fluted, the flutes having varying width, height, and depth. In addition, the projected light beam 104 may be defined based on an optical interaction between the optics 56 and the peripheral wall 84. Accordingly, it is to be appreciated that the peripheral wall 84 may be configured to exhibit various optical characteristics.

Due to the lack of any movable parts, the lighting device 18 described with reference to FIG. 11 may be manufactured at a lower cost when compared to movable lighting devices 18. Furthermore, the lack of movable parts also enables the lighting device 18 to benefit from a smaller size, thereby enabling it to be more easily integrated with various structures of the vehicle 10 (e.g., headliner 16). While the housing assembly 72 of the lighting devices 18 has been described herein as having a particular disposition, it is to be understood that the housing assembly 72 may take on other shapes and configurations to adapt to various structures of the vehicle 10 without adversely impacting the functionality of the lighting device 18.

Use of the present disclosure may offer a variety of advantages. For instance, use of the lamp assembly may provide additional functionality of the vehicle to occupants thereof. The lamp assembly may assist occupants in situations where a driver is not present. Moreover, the selective activation of light sources by the controller based on a plurality of inputs based on detected conditions and/or occupant inputs provide for a wide array of uses of the lamp assembly. The lamp assembly described herein may provide many additional benefits to the vehicle while being manufactured at a lower cost than current light assemblies.

According to one aspect of the present disclosure, a vehicle lamp assembly is provided herein. The vehicle lamp assembly includes a lighting device configured to couple to a headliner. One or more light sources are disposed within the lighting device. A controller is configured to selectively activate the one or more light sources. The illuminated one or more light sources direct light at a feature within a vehicle. Examples of the vehicle lamp assembly can include any one or a combination of the following features:
the lighting device is operably coupled to an electronic device and the one or more light sources are selectively activated through the electronic device;
the lighting device is operably coupled with a human-machine interface (HMI) and the one or more light sources are selectively activated through the HMI;
the feature is a component of a seatbelt;
the lighting device is configured as a dome lamp and is operable to illuminate at least a portion of a cabin of the vehicle;
optics optically coupled with the one or more light sources, wherein the optics include one or more light-directing elements;
the light-directing elements are arranged such that a first portion of the light-directing elements is configured to output incident light at a first angle when a first light source is activated and another portion of the light-directing elements is configured to output light at a second angle when a second light source is activated;
the second portion includes a single light-directing element having a planar shape and the first portion includes a plurality of light-directing elements in a sawtooth arrangement;
the lighting device includes a housing assembly pivotally coupled to the headliner;
the one or more light sources are disposed in a circular arrangement and emit circumferentially about the housing towards a desired illumination location within the vehicle; and/or
a microphone operably coupled to the controller, wherein the lighting device selectively illuminates one or more light sources based on a user-provided voice command.

Moreover, a method of method of manufacturing a vehicle lamp assembly is provided herein. The method includes coupling a lighting device to a headliner. One or more light sources are positioned within the lighting device. A controller is coupled to the one or more light sources. The one or more light sources are selectively activated. The illuminated one or more light sources direct light at a feature within a vehicle.

According to another aspect of the present disclosure, a vehicle lamp assembly is provided herein. The vehicle lamp assembly includes a first lighting device having one or more light sources. A second lighting device has one or more light sources. The second lighting device is disposed vehicle rearward of the first lighting device. A controller is configured to selectively activate the first and second lighting devices to direct light at a feature within a vehicle. Examples of the vehicle lamp assembly can include any one or a combination of the following features:
the controller is operably coupled to an electronic device and the first and second lighting devices are selectively activated through the electronic device;
each of the one or more light sources are selectively activated based on a desired illumination position within the vehicle;
optics optically coupled with the one or more light sources of the first and second lighting devices, wherein the optics include one or more light-directing elements; and/or
the controller is configured to direct an incoming occupant to a predefined position within the vehicle.

According to yet another aspect of the present disclosure, a vehicle lamp assembly is provided herein. The vehicle lamp assembly includes a first lighting device having first and second light sources. A first light-directing element is operably coupled with the first light source and is configured to direct light towards a first vehicle feature. A second light-directing element is operably coupled with the second light source and is configured to direct light towards a second vehicle feature. A controller is configured to selectively activate the first and second light sources. Examples of the vehicle lamp assembly can include any one or a combination of the following features:
the lighting device is operably coupled to an electronic device and the one or more light sources are selectively activated through the electronic device;
a microphone operably coupled to the controller, wherein the lighting device selectively illuminates one or more light sources based on a user-provided voice command; and/or
the one or more light sources are disposed in a circular arrangement and emit circumferentially about the housing towards a desired illumination location within the vehicle.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

1. A vehicle lamp assembly comprising:
a lighting device configured to couple to a headliner;
one or more light sources disposed within the lighting device;
a controller configured to selectively activate the one or more light sources, the illuminated one or more light sources directing a collimated light beam at a predefined feature within a vehicle; and
a mobile communication device operably coupled to the controller, wherein the predefined feature to be illuminated is selected via the mobile communication device.

2. The vehicle lamp assembly of claim 1, wherein the one or more light sources are selectively activated through the mobile communication device.

3. The vehicle lamp assembly of claim 1, wherein the lighting device is operably coupled with a human-machine interface (HMI) and the one or more light sources are selectively activated through the HMI.

4. The vehicle lamp assembly of claim 1, wherein the predefined feature is a component of a seatbelt.

5. The vehicle lamp assembly of claim 1, wherein the lighting device is configured as a dome lamp and is operable to illuminate at least a portion of a cabin of the vehicle.

6. The vehicle lamp assembly of claim 1, further comprising:
optics optically coupled with the one or more light sources, wherein the optics include one or more light-directing elements.

7. The vehicle lamp assembly claim 6, wherein the light-directing elements are arranged such that a first portion of the light-directing elements is configured to output incident light at a first angle when a first light source is activated and a second portion of the light-directing elements is configured to output light at a second angle when a second light source is activated.

8. The vehicle lamp assembly of claim 7, wherein the second portion includes a single light-directing element having a planar shape and the first portion includes a plurality of light-directing elements in a sawtooth arrangement.

9. The vehicle lamp assembly of claim 1, wherein the lighting device includes a housing assembly pivotally coupled to the headliner.

10. The vehicle lamp assembly of claim 3, wherein the one or more light sources are disposed in a circular arrangement and emit circumferentially towards a desired illumination location within the vehicle.

11. The vehicle lamp assembly of claim 10, further comprising:
a microphone operably coupled to the controller, wherein the lighting device selectively illuminates one or more light sources based on a user-provided voice command.

12.-20. (canceled)
